(19) United States
(12) Patent Application Publication
(10) Pub. No.: US 2005/0101350 A1
(43) Pub. Date: May 12, 2005

(54) COMMUNICATION DEVICE

(76) Inventor: Chun-Hsiung Wang, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,639

(22) Filed: Mar. 17, 2004

(30) Foreign Application Priority Data
Nov. 7, 2003 (TW) 092131297

(51) Int. Cl. H04M 1/00; H04B 1/38

(52) U.S. Cl. 455/558; 455/557; 455/552.1

(57) ABSTRACT

A secondary communication module of a wireless communication device with a first protocol is provided. The secondary communication module is detachably installed on the wireless communication device, which includes a housing, a battery installed inside the housing for providing power to the wireless communication device, a radio frequency (RF) circuit installed inside the housing for converting RF signals, and baseband signals in order to provide a second protocol, which different from the first protocol, and a baseband circuit connected to the RF circuit for processing the baseband signals.

### BACKGROUND OF INVENTION

1. Field of the Invention

The present invention relates to a communication device, and more specifically, to a wireless communication device being able to provide a second communication protocol different from the original communication protocol.

2. Description of the Prior Art

For current mobile communication systems, GSM is the most popular one, which utilizes 900 MHz and 1900 MHz electronic wave to transmit data (for some countries 900 and 1800 MHz frequency are used). GSM can also provide data transmission service when it is integrated with WAP (wireless application protocol) function. However, because of the limited bandwidth under GSM protocol, the data transfer rate is too slow and the cost is too expensive to access the network through WAP. GPRS is another non-voice service based on GSM for users to access data rapidly through current mobile communication network. CDMA is yet another protocol that stacks all client signals together in the same channel to share the same bandwidth, resulting in better performance in communication quality, transmission speed, and security. PHS is another communication system having several advantages over GSM system, such as higher transmission speed, better communication quality, cheaper phone charge, and lower electromagnetic power.

As described above, there are several different mobile communication systems not compatible with each other, meaning that it is necessary for a mobile phone to use a protocol compatible to the mobile communication backbone system. For instance, only GSM phones can communicate with only a GSM system. However, the dominant protocols of different countries or regions are not the same. One region may also use different communication protocols. For those people who travel aboard frequently, it is very inconvenient to change or to rent a mobile phone in the airport. One solution for this problem is the dual mode mobile phone. A dual mode mobile phone supports two protocols at the same time, such as GSM plus CDMA, or GSM plus PHS; thus it is very convenient for users to bring it abroad.

A conventional design of dual mode mobile phones is to install circuits complying with both protocols inside one mobile phone. However, such design not only complicates circuit design but also limits mechanic design. Moreover, a dual mode mobile phone is more expensive, and the user may not be able to select from two protocols freely. Therefore, users may still end up purchasing two typical mobile phones rather than one dual mode mobile phone.

### SUMMARY OF INVENTION

It is therefore an objective of the present invention to provide a dual mode communication device with a power module detachably installed on a mobile phone, and providing the mobile phone with another protocol to make the mobile phone a dual mode mobile phone.

Briefly summarized, the present invention provides a secondary communication module of a wireless communication device, wherein the wireless communication device provides a first protocol wireless communication and the secondary communication module is detachably installed on the wireless communication device. The communication module includes a housing, a battery installed inside the housing for providing power to the wireless communication device, a radio frequency (RF) circuit installed inside the housing for converting RF signals and baseband signals and for providing a second protocol wireless communication, and a baseband circuit connected to the RF circuit for processing the baseband signals.

The present invention further provides an external communication module for connecting to an electric device to provide a first protocol wireless communication to the electronic device, which includes a battery, a first RF circuit for converting RF signals and baseband signals, and a first baseband circuit connected to the first RF circuit for processing the baseband signals. The battery provides power to the first RF circuit and the first baseband circuit.

The present invention further provides a communication system, which includes an electronic device having a second RF circuit and a second baseband circuit to provide a second protocol wireless communication, and an external communication module having a battery, a first RF circuit for converting RF signals and baseband signals, and a first baseband circuit to provide a first protocol wireless communication. The external communication module is detachably connected to the electronic device and the battery of the external communication module supplies power to the electronic device and the external communication module.

The present invention further provides a communication system, which includes an electronic device having a power source, an external communication module connecting to the electronic device for providing a first protocol wireless communication, the external communication module comprising a battery, an antenna, a first RF circuit, and a first baseband circuit, wherein the RF circuit connects to the antenna to emit and receive RF signals, and a connecting device for connecting the electronic device with the external communication module for providing electrical signal transmission therebetween.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a mobile phone and a second communication module according to the present invention.

FIG. 2 is a block diagram of the mobile phone shown in FIG. 1.

FIG. 3 is a block diagram of the second communication module shown in FIG. 1.

FIG. 4 is a block diagram of the mobile phone installed with the second communication module shown in FIG. 1.

FIG. 5 is a block diagram of the second communication module.

FIG. 6 illustrates the RF interface connection between the second communication module and the mobile phone.

### DETAILED DESCRIPTION

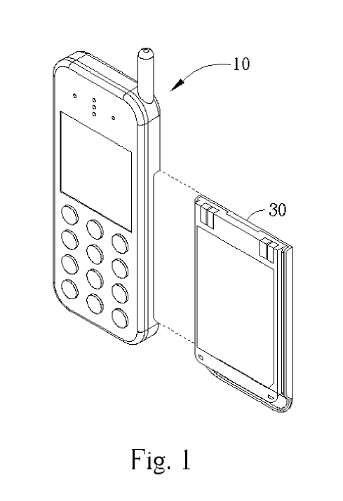

Please refer to FIG. 1 showing a mobile phone 10 and a second communication module 30 according to the present invention. The communication module 30 is one of the important accessories of the mobile phone 10, which provides the mobile phone 10 with power. Generally, a battery is detachably installed in the mobile phone 10 so that it can be charged within or outside of the mobile phone 10. The present invention expands the function of a detachable battery into a second communication module 30. The second communication module 30 includes a battery for providing power as well as a complete communication circuit for providing a second protocol different from a first protocol provided by the mobile phone 10. When the second communication module 30 is installed in the mobile phone 10, the mobile phone 10 becomes a dual mode mobile phone including the first protocol provided by the mobile phone 10 itself and the second protocol provided by the second communication module 30. A user can then select different second communication modules 30 according to his requirements. So that in the case that the user goes abroad, he can change the second communication module 30 instead of the mobile phone 10. Moreover, in an area where different protocols exist, the user can choose one proper protocol with the mobile phone 10 along with the second communication module 30 instead of using two different mobile phones.

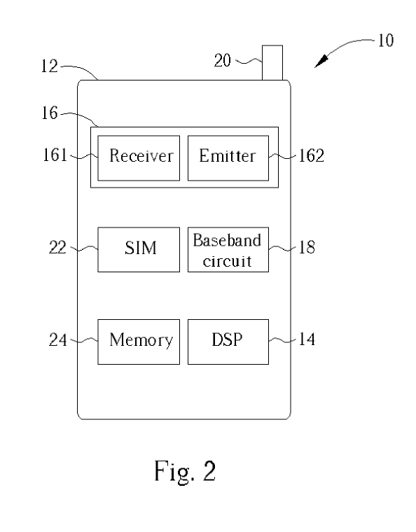

Please refer to FIG. 2 showing a block diagram of the mobile phone 10 shown in FIG. 1. The mobile phone includes a housing 12, a digital signal processor (DSP) 14, a radio frequency (RF) circuit 16, a baseband 18, an antenna 20, a subscriber identity module (SIM) 22, and a memory 24. On the housing 12, a liquid crystal display (LCD) panel for displaying the messages of the mobile phone 10, a keypad for inputting telephone numbers and commands, a speaker, and a microphone are installed. The DSP 14 is installed inside the housing 12 for controlling the functions of the mobile phone 10, including signal input/output, network connection, games, etc. The RF circuit 16 is installed inside the housing 12 for converting RF signals and baseband signals to provide one first protocol from GSM, GPRS, PHS, CDMA or 3G. The RF circuit 16 includes an RF receiver 161 for converting RF signals into baseband signals, and an RF emitter 162 for converting baseband signals into RF signals. The baseband circuit 18 is connected to the RF circuit 16 for processing the baseband signals. The antenna 20 can be installed inside the housing 12 or on the housing 12 for emitting or receiving the RF signals. During wireless communication, the antenna 20 receives RF signals and transmits them to the RF receiver 161, where the RF receiver 161 converts the RF signals into baseband signals and transmits them to the baseband circuit 18 for processing, and afterwards, the RF emitter 162 converts the baseband signals into RF signals and transmits them to the antenna 20 to be emitted. The SIM 22 is for reading and writing subscriber identity and also for providing the system provider the ability to record the users personal data, charge data, authorization, or secure data. The memory is for storing data and programs relating to the mobile phone 10.

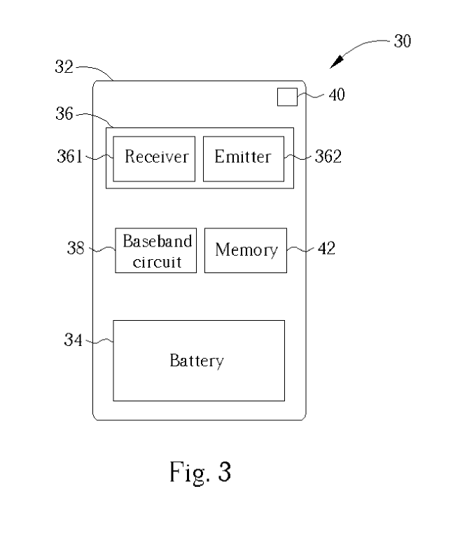

Please refer to FIG. 3 showing a block diagram of the second communication module 30 shown in FIG. 1. The second communication module 30 includes a housing 32, a battery 34, an RF circuit 36, a baseband circuit 38, an antenna 40, and a memory 42. Metal nodes are installed on the housing 32 for electrically connecting to the mobile phone 10. The battery 34 is installed inside the housing 32 for providing power to the mobile phone 10. The RF circuit 36 includes an RF receiver 361 for converting RF signals into baseband signals, and an RF emitter 362 for converting baseband signals into RF signals. The baseband circuit 38 is connected to the RF circuit 36 for processing the baseband signals. The RF circuit 36 and the baseband circuit 38 in the second communication module 30 have the same function as the RF circuit 16 and the baseband circuit 18 in the mobile phone 10; however, the second communication module 30 provides the second protocol, which different from the first protocol provided by the mobile phone 10. For instance, if the mobile phone 10 provides GSM protocol, the second communication module 30 provides GPRS, PHS, CDMA or 3G protocol.

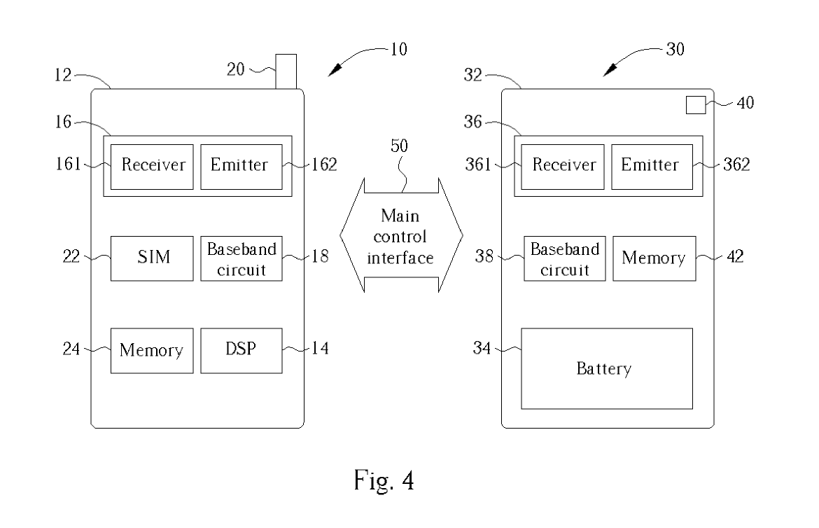

Please refer to FIG. 4 showing a block diagram of the mobile phone installed with the second communication module 30 shown in FIG. 1. The second communication module 30 and the mobile phone 10 can transmit signals to each other through a main control interface 50. The second communication module 30 provides the mobile phone 10 with power. When the mobile phone 10 is turned on, the loop between the DSP 14 of the mobile phone 10 and the baseband circuit 38 of the second communication module 30 is conducted so that the mobile phone 10 provides the first protocol and the second protocol at the same time. As shown in FIG. 4, the second communication module 30 and the mobile phone 10 use the same antenna 20. However, if the second protocol provided by the second communication module 30 cannot use the same antenna with the first protocol provided by the mobile phone 10, another antenna 40 is required to be installed on the second communication module 30 for the second protocol, as shown in FIG. 3. Moreover, an additional memory 42 can be installed in the second communication module 30 to increase the space for storing data and programs.

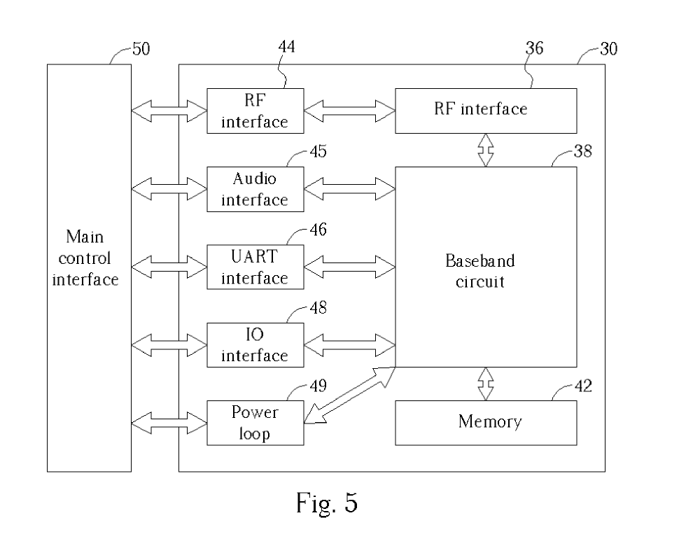

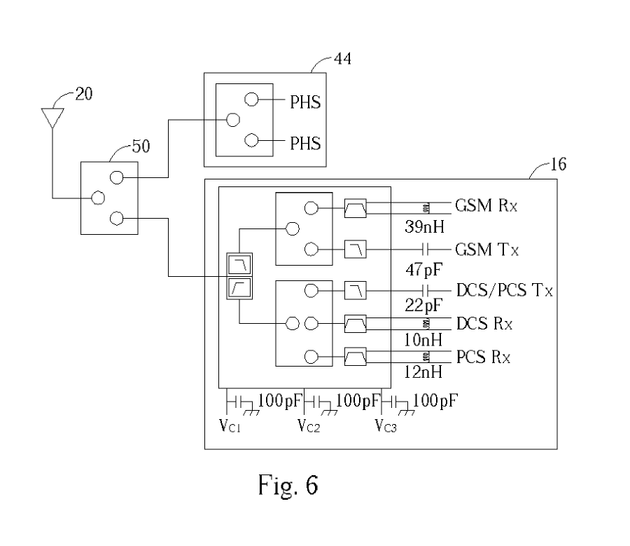

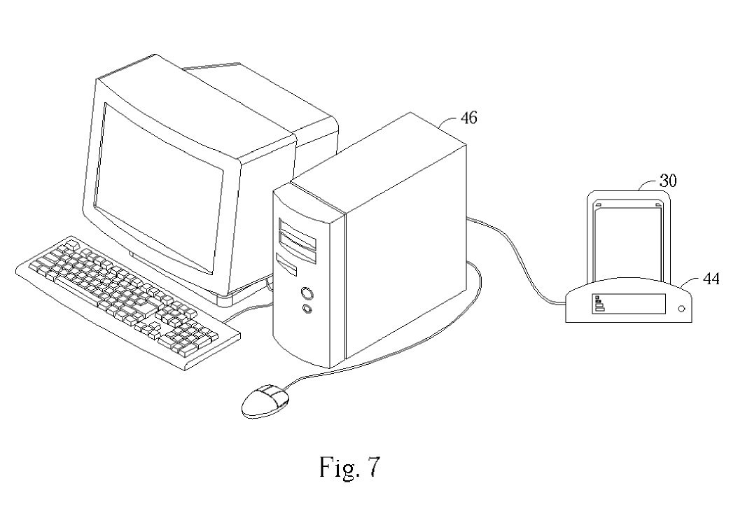

Please refer to FIG. 5 showing a block diagram of the second communication module 30, as well as to FIG. 6 showing the RF interface connection between the second communication module 30 (providing PHS) and the mobile phone 10 (providing GSM). The second communication module 30 provides power to the mobile phone 10 after being connected to it. After turn-on, the mobile phone 10 can turn on a power loop 49 through the main control interface 50 so that the battery provides power to the second communication module 30 to turn on it. After turn-on, the second communication module 30 transmits an AT command to the mobile phone 10 to notify it that the second communication module 30 is stand-by. At this time, the mobile phone 10 becomes a dual mode mobile phone through the main control interface 50 connected to an RF interface 44, an audio interface 45, a UART interface 46, and an I/O interface 48 of the second communication module 30. Of course, the user can manually turn off the power loop 49 through the mobile phone 10 to disable the second protocol or enable the second protocol with the first protocol disabled.

Please refer to FIG. 7 showing the second communication module 30 connected to a host computer 46 by a cradle 44. The second communication module 30 is an independent wireless communication device for it includes the RF circuit 36, the baseband circuit 38, the antenna 40 and the memory 42. The present invention further provides a cradle 44 for putting the second communication module 30 on it to connect the second communication module 30 with the host computer 46. In this case the second communication module 30 is used as a wireless modem to access to the Internet. The cradle 44 is connected to the host computer 46 via a USB interface. Besides data transmission, the cradle 44 can also charge the second communication module 30. A desktop computer in shown in FIG. 7; however, it can be replaced by a portable computer, such as a notebook computer or a PDA. In this case, the second communication module 30 supplies its own power consumption with its own battery to save the power of portable computer. In addition, the battery of communication module 30 may also provide power to the portable computer if necessary.

As described above, the present invention provides a mobile phone 10 and the second communication module 30 detachably installed on the mobile phone 10. The second communication module 30 includes the battery 34, the RF circuit 36, the baseband circuit 38, the antenna 40, and the memory 42, wherein the battery 34 is for power supply, the RF circuit 36, and the baseband circuit 38; and the antenna 40 is for wireless communication; and the memory 42 is for storage. Therefore, the second communication module 30 provides not only a power supply but also another protocol, as well as a larger storage to the mobile phone 10. In cooperation with the second communication module 30, the mobile phone 10 becomes a dual mode mobile phone having two different protocols from GSM, GPRS, PHS, CDMA or 3G. Moreover, the second communication module 30 can be separately installed in a cradle 44 to be connected to the host computer 46 to be used as a modem by the host computer 46. The cradle 44 can also charge the battery 34 within the second communication module 30.

In contrast to the prior art, the present invention provides the second protocol by the second communication module. The same second communication module can be used in different mobile phones so that the effort on developing dual mode mobile phones need not be done, and also a variety of choices is provided to the user to determine whether protocol to use. Moreover, the second communication module can be used separately with the cradle to be a modem of a host computer, which is very convenient.

Those skilled in the art will readily observe that numerous modifications and alterations of the device may be made while retaining the teachings of the invention. Accordingly, the above disclosure should be construed as limited only by the metes and bounds of the appended claims.

1. A secondary communication module of a wireless communication device, wherein the wireless communication device provides a first protocol wireless communication and the secondary communication module is detachably installed on the wireless communication device, the communication module comprising:
a housing;
a battery installed inside the housing for providing power to the wireless communication device;
a radio frequency (RF) circuit installed inside the housing for converting RF signals and baseband signals and for providing a second protocol wireless communication; and
a baseband circuit connected to the RF circuit for processing the baseband signals.

2. The communication module of claim 1, further comprising an antenna installed inside the housing for emitting and receiving RF signals.

3. The communication module of claim 1 wherein the module is connected to a computing device through a cradle and provides wireless communication to the computing device.

4. The communication module of claim 3 wherein the cradle is connected to the computing device via a USB port.

5. The communication module of claim 1 wherein the first protocol is one of GSM, GPRS, PHS, CDMA and 3G protocols.

6. The communication module of claim 1 wherein the second protocol is one of GSM, GPRS, PHS, CDMA and 3G protocols.

7. The communication module of claim 1 wherein the wireless communication device and the secondary communication module communicate with each other by AT commands.

8. The communication module of claim 1 wherein the RF circuit comprises an RF receiver for converting RF signals into baseband signals and an RF emitter for converting baseband signals into RF signals.

9. The communication module of claim 1 further comprising a memory installed inside the housing for storing data.

10. An external communication module for connecting to an electric device to provide a first protocol wireless communication to the electronic device, the communication module comprising:
a battery;
a first RF circuit for converting RF signals and baseband signals; and
a first baseband circuit connected to the first RF circuit for processing the baseband signals, wherein the battery provides power to the first RF circuit and the first baseband circuit.

11. The communication module of claim 10 wherein the electronic device comprises a second antenna, and the first RF circuit of the external communication module connects to the second antenna for emitting and receiving RF signals through the second antenna.

12. The communication module of claim 11 wherein the electronic device and the external communication module are controlled by a main control interface.

13. The communication module of claim 12 wherein the electronic device comprises a second RF circuit and a second baseband circuit to provide a second protocol wireless communication, the second RF circuit connects to the second antenna for emitting and receiving RF signals, and the battery of the external communication module provides power to the electronic device.

14. The communication module of claim 10 further comprising a memory for storing data.

15. A communication system comprising:
an electronic device having a second RF circuit and a second baseband circuit to provide a second protocol wireless communication; and
an external communication module having a battery, a first RF circuit for converting RF signals and baseband signals, and a first baseband circuit to provide a first protocol wireless communication,
wherein the external communication module is detachably connected to the electronic device and the battery of the external communication module supplies power to the electronic device and the external communication module.

16. The communication system of claim 15 wherein the electronic device comprises a second antenna, and the first RF circuit of the external communication module is connected to the second antenna to emit and receive the RF signals through the second antenna.

17. The communication system of claim 15 wherein the electronic device comprises a second antenna, the external communication module comprises a first antenna, the second RF circuit of the electronic device is connected to the second antenna to emit and receive the RF signals through the second antenna, and the first RF circuit of the external communication module is connected to the first antenna to emit and receive the RF signals through the first antenna.

18. The communication system of claim 17 wherein the electronic device and the external communication module are controlled by a main control interface.

19. The communication system of claim 18 wherein the electronic device comprises a second memory, and the external communication module comprises a first memory.

20. A communication system comprising:
an electronic device having a power source;
an external communication module connecting to the electronic device for providing a first protocol wireless communication, the external communication module comprising a battery, an antenna, a first RF circuit, and a first baseband circuit, wherein the RF circuit connects to the antenna to emit and receive RF signals; and
a connecting device for connecting the electronic device with the external communication module for providing electrical signal transmission therebetween.

21. The communication system of claim 20 wherein the battery of the external communication module receives power from the power source of the electronic device through the connecting device.

22. The communication system of claim 20 wherein the external communication module are controlled by a main control interface of the electronic device.

23. The communication system of claim 22 wherein the electronic device comprises a second memory, and the external communication module comprises a first memory.
